(19) United States
(12) Patent Application Publication
(10) Pub. No.: US 2023/0221498 A1
(43) Pub. Date: Jul. 13, 2023

(54) METHODS AND DEVICES FOR ASSEMBLING FIBER OPTIC CONNECTORS

(71) Applicant: CommScope Technologies LLC, Hickory, NC (US)

(72) Inventors: Chinmay M. Bendale, Eden Prairie, MN (US); Samuel Taylor Finnegan, Eden Prairie, MN (US); Laurens Izaäk Van Wuijckhuijse, Eden Prairie, MN (US); Aaron B. Dannen, Minneapolis, MN (US); Scott L. Carlson, Bloomington, MN (US); Richard William Bruneau, Apple Valley, MN (US); Paige E. Canzonieri, Brooklyn Park, MN (US); Lawrence Joseph Sorenson, Bloomington, MN (US); Jaime Gonzalez Batista, Prior Lake, MN (US)

(21) Appl. No.: 18/001,250

(22) PCT Filed: Jun. 8, 2021
(86) PCT No.: PCT/US2021/036442

§ 371 Date: Dec. 8, 2022

Related U.S. Application Data
(60) Provisional application No. 63/036,314, filed on Jun. 8, 2020.

(51) Int. Cl. G02B 6/38; H05B 1/02

(52) U.S. Cl. CPC G02B 6/3861; H05B 1/0247; G02B 6/3898

(57) ABSTRACT

Methods and devices for assembling a fiber optic connector are provided. A device supports at least one fiber optic connector. The connector has an optical fiber inserted through the ferrule so that an exposed portion is disposed outside of the ferrule. Residual epoxy on the exposed portion is cured prior to physically manipulating the optical fiber within the ferrule. The device includes at least one heating chamber and a heat shield for curing of the residual epoxy.

### CROSS-REFERENCE TO RELATED APPLICATION

This application is being filed on Jun. 8, 2021 as a PCT International Patent Application and claims the benefit of U.S. Patent Application Ser. No. 63/036,314, filed on Jun. 8, 2020, the disclosure of which is incorporated herein by reference in its entirety.

### BACKGROUND

Within at least some known fiber optic connectors, an optical fiber is supported by a ferrule and secured by epoxy. During assembly, epoxy is inserted into the ferrule and then the optical fiber is inserted through the ferrule so that a portion of the optical fiber extends from the front of the ferrule. Once the optical fiber is positioned within the ferrule, the epoxy within the ferrule is cured so as to complete securement of the optical fiber within the ferrule.

During the insertion of the optical fiber through the ferrule, however, the epoxy within the ferrule contacts the fiber and residual portions of epoxy may remain on the fiber extending from the front of the ferrule. In some cases, a film of epoxy is formed on the exposed portion of the optical fiber. If any subsequent physical or other manipulation of the protruding optical fiber occurs before the residual epoxy on the protruding fiber is either removed or cured, the residual epoxy can contact and interfere with any components that contact or are within the area of the protruding fiber during assembly. The uncured epoxy may result in epoxy build-up on any components that are used to further assemble the fiber optic connectors, such as through contact with the epoxy and fiber.

For these and other reasons, improvements are desirable.

### SUMMARY

Aspects of the present disclosure relate to methods and devices that are used in the assembly of fiber optic connectors. In certain aspects, the methods and devices are used to selectively cure residual epoxy on components of the fiber optic connector so as to increase assembly efficiencies during the fiber optic connector assembly process.

In an aspect, the technology relates to a method of assembling a fiber optic connector. The method includes, providing a ferrule with epoxy at least partially disposed inside. Inserting at least one optical fiber through the ferrule, and after insertion, the at least one optical fiber includes an exposed portion disposed outside of the ferrule and an internal portion disposed within the ferrule, with a film of epoxy is at least partially formed on the exposed portion of the at least one optical fiber. Curing the film of epoxy on the exposed portion of the at least one optical fiber, and moving the at least one optical fiber relative to the ferrule via physical manipulation of the exposed portion of the at least one optical fiber.

In an example, curing the film of epoxy includes leaving the epoxy inside of the ferrule uncured. In another example, the method includes shielding the epoxy inside of the ferrule during the curing of the film of epoxy. In yet another example, curing the film of epoxy includes heating the exposed portion of the at least one optical fiber via a heating coil. In still another example, heating the exposed portion can include inserting the exposed portion of the at least one optical fiber into the heating coil, and applying electric current to the heating coil so as to generate a predetermined temperature within the heating coil. In an example, curing the film of epoxy includes heating the exposed portion of the at least one optical fiber via heated air.

In another example, heating the exposed portion can include generating a heated air flow at a predetermined distance from the exposed portion of the at least one optical fiber, and channeling the heated air flow via a nozzle to the exposed portion of the at least one optical fiber. In yet another example, the method includes verifying that the at least one optical fiber is completely inserted into the fiber optic connector prior to curing the film of epoxy.

In another aspect, the technology relates to a method of assembling a plurality of fiber optic connectors. The method includes, supporting at least a portion of the plurality of fiber optic connectors in a carrier, each fiber optic connector of the plurality of fiber optic connectors includes a ferrule with epoxy at least partially disposed inside. Inserting at least one optical fiber through the ferrule of each of the plurality of fiber optic connectors, and after insertion, the at least one optical fiber includes an exposed portion disposed outside of the ferrule and an internal portion disposed within the ferrule, with a film of epoxy is at least partially formed on the exposed portion of the at least one optical fiber. Placing at least a portion of the exposed portion of the at least one optical fiber of each of the plurality of fiber optic connectors into a corresponding heating chamber, and heating the exposed portion of the at least one optical fiber within the heating chamber so as to cure the film of epoxy on the exposed portion.

In an example, the method further includes moving the at least one optical fiber of each of the plurality of fiber optic connectors via physical manipulation of the exposed portion of the at least one optical fiber. In another example, the moving step occurs while the plurality of fiber optic connectors are supported in the carrier and after curing the film of epoxy on the exposed portion. In yet another example, heating the exposed portion includes applying electric current to a heating coil within the heating chamber. In still another example, heating the exposed portion includes channeling a flow of heated air into the heating chamber. In an example, the method can include shielding the epoxy inside of the ferrule of each of the plurality of fiber optic connectors during the heating.

In another example, the epoxy inside the ferrule is completely uncured. In yet another example, the method can include measuring a temperature within the heating chamber so as to provide a feedback loop for heating. In still another example, the method can include verifying that each of the at least one optical fibers are completely inserted into the corresponding fiber optic connector of the plurality of fiber optic connectors prior to heating.

In another aspect, the technology relates to a device for curing a film of epoxy on at least one optical fiber of a fiber optic connector. The device includes, a carrier configured to support at least one fiber optic connector and allow for at least one optical fiber to be inserted through a ferrule of the at least one fiber optic connector such that an exposed portion is disposed outside of the ferrule and an internal portion is disposed within the ferrule. A heat shield disposed on one side of the carrier and configured to allow the exposed portion of the at least one optical fiber to extend therethrough. An insulation base that defines at least one heating chamber, the at least one heating chamber corresponds to the at least one fiber optic connector, and the at least one heating chamber is configured to at least partially receive the exposed portion of the at least one optical fiber. The carrier, the insulation base, or the carrier and the insulation base are moveable relative to one another so as to position the exposed portion of the at least one optical fiber at least partially within the at least one heating chamber for heating.

In an example, the at least one heating chamber includes a heating coil having an inner diameter configured to receive the exposed portion of the at least one optical fiber. In another example, a heated air source is provided, and the at least one heating chamber is configured to receive a flow of heated air from the heated air source. In yet another example, a thermocouple is configured to measure temperature within the at least one heating chamber.

In another aspect, the technology relates to a device including an elongated support beam configured to releasably support at least one fiber optic connector. The fiber optic connector has at least one optical fiber that extends from a front end of the at least one fiber optic connector and is oriented such that the at least one optical fiber is substantially orthogonal to the elongated support beam. At least one heating chamber including a heating element. The elongated support beam, the at least one heating chamber, or the elongated support beam and the at least one heating chamber are moveable relative to one another so as to position the at least one optical fiber at least partially within the at least one heating chamber for heating.

In an example, the heating element is a heating coil. In another example, the heating element is a heated air blower. In yet another example, a heat shield is disposed between the elongated support beam and the at least one heating chamber.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### DESCRIPTION OF THE FIGURES

The following drawing figures, which form a part of this application, are illustrative of described technology and are not meant to limit the scope of the disclosure in any manner.

FIG. 1 is a top view of an exemplary LC style fiber optic connector.

FIG. 2 is a cross-sectional view of the fiber optic connector shown in FIG. 1 taken along line 2-2.

FIG. 3 is a partial perspective exploded view of the fiber optic connector shown in FIGS. 1 and 2.

FIG. 4 is a side view of the fiber optic connector shown in FIGS. 1-3 during assembly.

FIG. 5 is a perspective view of an exemplary device for curing epoxy on an optical fiber extending from a front of a ferrule of a fiber optic connector.

FIG. 6 is a partial perspective exploded view of the device shown in FIG. 5.

FIG. 7 is another partial perspective exploded view of the device shown in FIG. 5.

FIG. 8 is a side view of the device shown in FIG. 5 in a first position.

FIG. 9 is a side view of the device shown in FIG. 5 in a second position.

FIG. 10 is a schematic view of the second position shown in FIG. 9.

FIG. 11 is a perspective view of another exemplary device for curing epoxy on an optical fiber extending from a front of an optical fiber of a fiber optic connector.

FIG. 12 is a partial top view of the device shown in FIG. 11.

FIG. 13 is a side view of the device shown in FIG. 11.

FIG. 14 is a flowchart illustrating an exemplary method of assembling a fiber optic connector.

FIG. 15 is a flowchart illustrating another method of assembling a plurality of fiber optic connectors.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

During assembly of some fiber optic connectors, epoxy is inserted into an internal passage of the ferrule and then the optical fiber is inserted through the internal passage of the ferrule so that a portion of the optical fiber extends from the front of the ferrule. In one operation, this exposed portion of the optical fiber can then be used to center the fiber or otherwise adjust the position of the optical fiber within the internal passage of the ferrule. One reason for this is to increase alignment of optical fibers and performance of the fiber optic connector. Moving the fiber portion within the ferrule can only occur before the epoxy within the ferrule is cured. Once the optical fiber is positioned within the ferrule in the desired location, the epoxy within the ferrule is cured so as to complete securement of the optical fiber within the ferrule.

In some examples, the positioning of the optical fiber is performed by physical or other manipulation of the exposed portion of the optical fiber. However, during the insertion of the optical fiber through the ferrule, some of the epoxy within the ferrule adheres to the optical fiber on the exposed portion of the optical fiber. As such, the subsequent physical or other manipulation of the exposed optical fiber with uncured epoxy residue on it results in epoxy adhering to components that are used to further assemble the fiber optic connectors, such as a positioning operation. This epoxy can build-up on components used repeatedly and is undesirable, and increases fiber optic connector assembly costs, for example, due to component down-time, maintenance, and cleaning.

In some examples described herein, prior to the optical fiber being held and/or positioned in a desired location within the ferrule, the residual uncured epoxy on the exposed portion of the optical fiber is cured so as to reduce or prevent subsequent epoxy build-up during the fiber optic connector assembly process. This curing step, however, leaves the epoxy within the ferrule body uncured for the holding or positioning procedure.

In some examples, a device that cures the exposed portion of the optical fiber utilizes heat coils and an insulation shield to prevent curing of the epoxy inside the ferrules. In other examples, a device that cures the exposed portion of the optical fiber utilizes heated air that is blown and an insulation shield to prevent curing of the epoxy inside the ferrules.

These devices are also preferably configured to incorporate a common carrier to support the connectors being assembled so that the intermediate curing step can be easily incorporated into the overall connector assembly process.

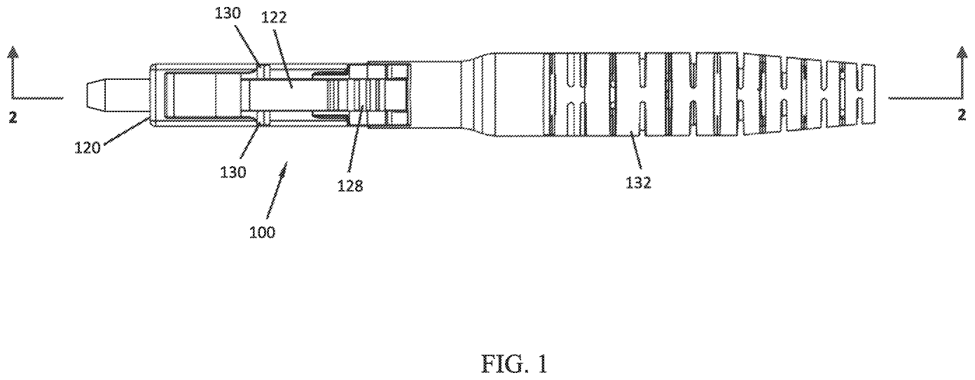

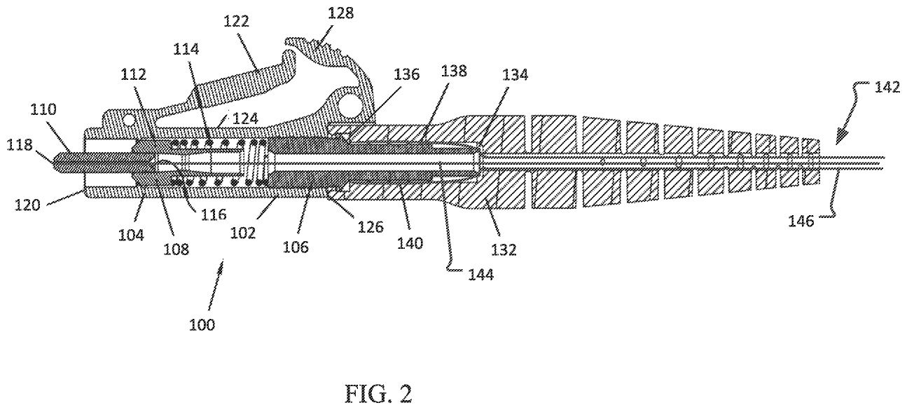

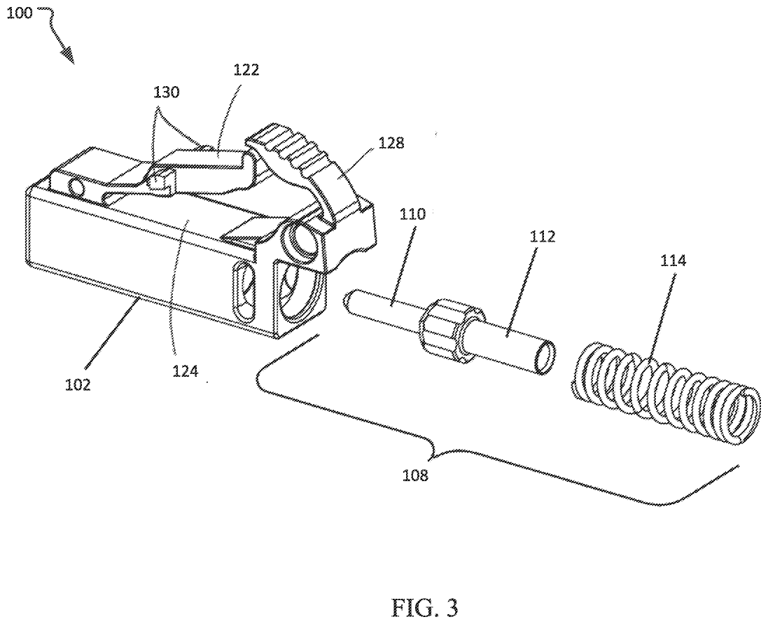

FIG. 1 is a top view of an exemplary LC style fiber optic connector 100. FIG. 2 is a cross-sectional view of the fiber optic connector 100 taken along line 2-2 in FIG. 1. FIG. 3 is a partial perspective exploded view of the fiber optic connector 100. Referring concurrently to FIGS. 1-3, the fiber optic connector 100 is generally configured to ensure fixed coupling to a matching format adapter. In the example, the fiber optic connector 100 includes a housing 102 having a front housing portion 104 and a rear housing portion 106. Additionally, the connector 100 includes a ferrule assembly 108 defined by a ferrule 110, a hub 112, and a spring 114. A rear end 116 of the ferrule 110 is secured within the ferrule hub 112. When the fiber optic connector 100 is assembled, the ferrule hub 112 and the spring 114 are captured between the front housing portion 104 and the rear housing portion 106 of the connector housing 102, and a front end 118 of the ferrule 110 projects forward outwardly beyond a front end 120 of the housing 102. The spring 114 is configured to bias the ferrule 110 in a forward direction relative to the connector housing 102.

In some examples, the front housing portion 104 may be formed from a molded plastic. The front housing portion 104 defines a latch 122 extending from a top wall 124 of the front housing portion 104 towards a rear end 126. The latch 122 extends at an acute angle with respect to the top wall 124 of the front housing portion 104. The front housing portion 104 as depicted in the figures also includes a latch trigger 128 that extends from the rear end 126 of the front housing portion 104 towards the front end 120. The latch trigger 128 also extends at an acute angle with respect to the top wall 124. The latch trigger 128 is configured to come into contact with the latch 122 for flexibility moving the latch 122 downwardly. When the fiber optic connector 100 is placed in an LC format adapter (not shown) for optically coupling two optical fibers together, the latch 122 functions to lock the fiber optic connector 100 in place within the adapter. The fiber optic connector 100 may be removed from the adapter by depressing the latch trigger 128, causing the latch 122 to be pressed in a downward direction, freeing catch portions 130 of the latch 122 from the fiber optic adapter.

A strain relief boot 132 may be slide over a rear end 134 of the rear housing portion 106 and snap over a boot flange 136 to retain the boot 132 with respect to the connector housing 102. The rear end 134 of the rear housing portion 106 defines a crimp region 138 for crimping a fiber optic cable's strength layer to the rear housing portion 106. For example, with the use of a crimp sleeve (not shown). An exterior surface 140 of the rear housing portion 106 defining the crimp region 138 can be textured (e.g., knurled, ridged, provided with small projections, etc.) to assist in in retaining the crimp on the housing 102.

In operation, the fiber optic connector 100 is configured to terminate an end of a fiber optic cable 142 and enable mechanical coupling and alignment of the end of an optical fiber 144. The optical fiber 144 generally includes an inner core with a surrounding cladding that is further surrounded by a coating, and one or more protective layers 146 (e.g., a jacket, or aramid yarn and an outer jacket). The end of the optical fiber 144 extends through the connector 100 and terminates at the front end 118 of the ferrule 110. The optical fiber 144 is secured within the ferrule 110 with cured epoxy. Movement of the ferrule 110 of the LC connector 100 in a rear direction relative to the connector housing 102 under the bias of the spring 114 causes the optical fiber 144 to be forced/displaced in a rear direction relative to the connector housing 102 and the jacket 146 of the fiber optic cable 142. The biased movement of the ferrule 110 allows for any geometry discrepancies and tolerance variations when axially mating two of the fiber optic connectors 100 within a fiber optic adapter.

It should be appreciated that while an LC-style connector is illustrated and described above, the assembly methods and devices described herein can be used in any other connector style and/or type as required or desired. For example, TC, SC, FC, MT, or ST style connectors, and even multi-fiber style connectors (e.g., MPO).

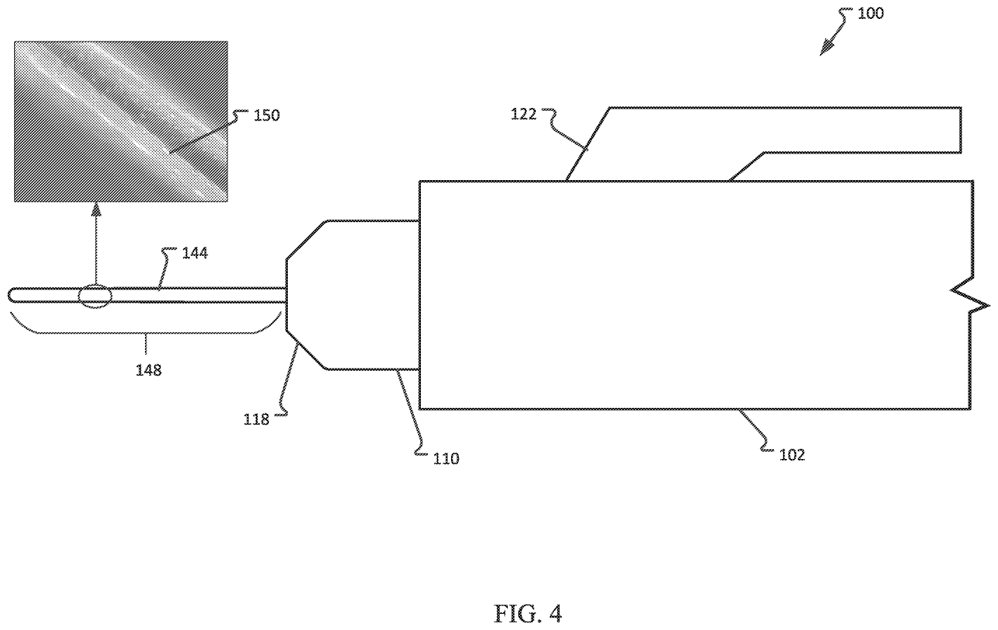

FIG. 4 is a side view of the fiber optic connector 100 during assembly. Certain components are described above, and thus, are not necessarily described further. During assembly of the connector 100, epoxy (not shown) is placed at least partially within the ferrule 110. The coating and any jacket of the fiber optic cable is stripped at an end so as to expose the optical fiber 144 (core and cladding), and the exposed end of the optical fiber 144 is inserted through the ferrule 110 and the epoxy until the optical fiber 144 extends out of the front end 118 of the ferrule 110. As such, the optical fiber 144 has an exposed portion 148 that is defined by the section that protrudes out of the front end 118 of the ferrule 110.

The exposed portion 148 can be used during the assembly process to physically manipulate the optical fiber 144 prior to curing the epoxy and securing the optical fiber 144 within the ferrule 110. This physical manipulation to hold or position the optical fiber 144 within the ferrule 110 in the desired location may be done, for example, to increase performance of the fiber optic connector 100. In an aspect, this physical manipulation can include centering the fiber or pushing the optical fiber 144 to a desired location on side or another within the ferrule 110. The centering or pushing of the optical fiber 144 may be performed by physically touching the fiber or by physically applying a force to the fiber. This force does not necessarily need to be via physical touch, for example, a flow of air may be used to center or push the optical fiber 144. Once the optical fiber 144 is positioned as required or desired and the epoxy is cured, the exposed portion 148 is cleaved and the front end 118 of the ferrule 110 is polished. As used herein, epoxy refers to any of the basic components of epoxy resins prior to reaction or curing. In an aspect, curing the epoxy may include heating the epoxy. In other aspects, curing the epoxy may include applying one or more reactants. Additionally, as used herein cured epoxy is generally clean to the touch so that epoxy build-up is reduced or prevented.

When the optical fiber 144 is inserted through the ferrule 110, a residual film of epoxy 150 is formed on the exposed portion 148. As used herein, film of epoxy is meant to describe various forms of residual epoxy on the exposed fiber, whether fully coating the fiber or only located in discrete locations. Epoxy build-up on the contacting device components that provide the physical manipulation of the optical fiber 144 can occur because contacting the optical fiber 144 is prior to curing the epoxy within the ferrule. Thereby, a device that provides for the optical fiber to be contacted will have increases in down-time for cleaning and maintenance, and will require a large number of replacement/spare components for operation. The methods and devices described herein enable the film of residual epoxy 150 on the exposed portion 148 of the optical fiber 144 to be cured prior to contacting so that the contacting step can be more efficiently performed and overall connector manufacturing efficiencies are increased.

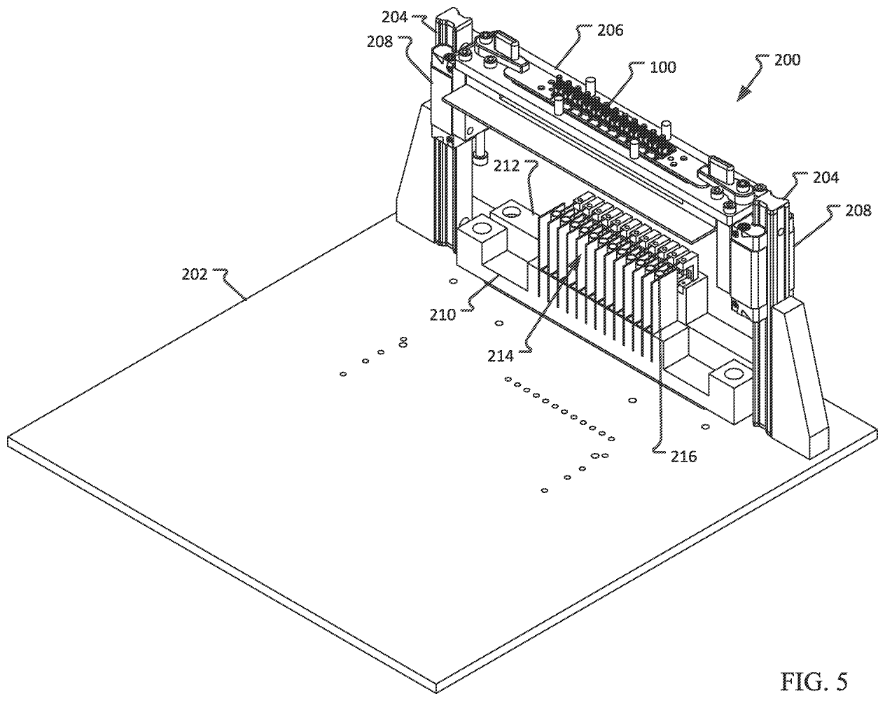

FIG. 5 is a perspective view of an exemplary device 200 for curing a film of epoxy on an optical fiber of a fiber optic connector. The device 200 includes a plate 202 that supports a pair of guides 204. A support beam 206 spans between the guides 204 and is supported at each end by an actuator 208. The actuators 208 are configured to move the support beam 206 linearly along the guides 204. An insulation base 210 and a heating element base 212 are also coupled to the base plate 202 and are disposed at least partially in line with the support beam 206. The insulation base 210 forms a plurality of heating chambers 214 and the heating element base 212 supports a plurality of corresponding heating elements 216. In operation, the support beam 206 is configured to support one or more fiber optic connectors 100 in a vertical orientation, with respect to the guide 204 direction, such that the exposed portion 148 of the optical fiber (shown in FIG. 4) can be moved into the heating chamber 214 and the film of epoxy cured via the heating element 216. This step is performed after the optical fiber is inserted through the ferrule, but prior to contacting the optical fiber, so that epoxy does not built up on assembly device components during the assembly of the fiber optic connector. In the example, the device 200 is configured to reduce or prevent the curing of the epoxy within the ferrule so that contacting of the optical fiber can still be performed. For example, holding or positioning can require physical manipulation of the optical fiber by moving the fiber to a desired location, such as by pushing it to one side or another, and thus the epoxy within the ferrule should not be cured yet.

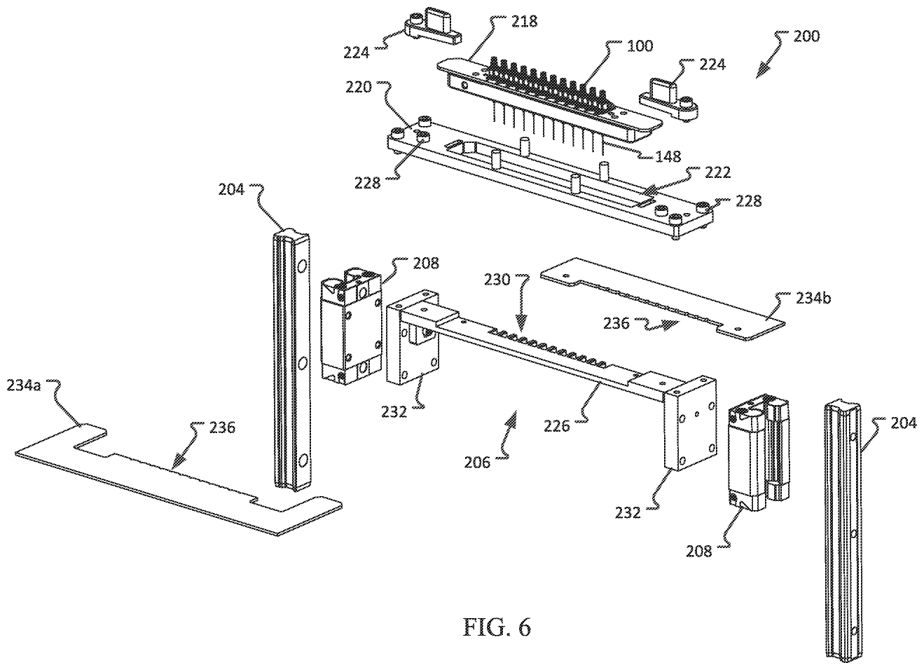

FIG. 6 is a partial perspective exploded view of the device 200. The support beam 206 is elongate and configured to support a carrier 218 such that the carrier 218 can be received and removed as required or desired during the connector assembly process. The carrier 218 supports one or more fiber optic connectors 100 with the exposed portion 148 of the optical fiber extending outward from one side of the carrier 218. This orientation enables the exposed portion 148 to be accessible for curing the film of the epoxy and for contacting the optical fibers in a subsequent assembly step. As such, the carrier 218 can be used throughout the assembly process and to support the connectors 100 in one or more assembly steps. For example, the carrier 218 can be used to move the connectors 100 between one or more devices (e.g., the device 200) that perform the required or desired assembly step. In the example, the carrier 218 is configured to support twelve connectors 100 arranged in a single row. In an aspect, the carrier 218 may be the carrier described in WIPO International Application No. PCT/US2020/024688, filed Mar. 25, 2020, and that is fully incorporated by reference herein.

In the example, the support beam 206 includes a first member 220 having a channel 222 defined therein. The channel 222 is shaped and sized so that a portion of the carrier 218 can extend therethrough when placed directly on the first member 220. A pair of latches 224 are pivotably coupled to the first member 220 and are used to releasably secure the carrier 218 to the support beam 206. A second member 226 couples to the first member 220 with one or more fasteners 228 and has a plurality of notches 230 defined on one side. The notches 230 are shaped and sized so that the front end 120 of the connector housing 102 (shown in FIG. 1) can be at least partially extend therein. This configuration of the support beam 206 maintains the spacing between the connectors 100, while also enabling the exposed portion 148 of the optical fibers to be easily accessible. The first member 220 is coupled to a pair of end plates 232 via fasteners 228 and the end plates 232 are used to mount the support beam 206 to the actuators 208. In other examples, the support beam 206 may directly support one or more connectors 100 itself. By directly supporting the connectors 100 (e.g., in a similar orientation and with the optical fiber substantially orthogonal to the span direction of the support beam 206) the carrier 218 is not necessarily needed.

The actuators 208 are configured to linearly move along the corresponding guides 204 so that the connectors 100 can be positioned relative to the heating elements 216 (shown in FIG. 5). In an aspect, the actuators 208 may be electronic motor actuators. The device 200 also includes a heat shield 234 that is configured to reduce or prevent the epoxy within the ferrule of the connector 100 from curing. The heat shield 234 can be formed from two parts 234a, 234b, with each part having corresponding grooves 236 on an edge so that openings are formed for the exposed portion 148 of the optical fibers to extend through. By forming the heat shield 234 in two parts, the exposed portions 148 do not have to be inserted through the relatively small openings. Instead the heat shield 234 can be coupled around the optical fibers so as to reduce potential contact with the fibers. In an aspect, the heat shield 234 is coupled to the second member 226 and opposite from the first member 220. Additionally, the heat shield portion 234 is the part that can easily be removed while the carrier 218 is being attached.

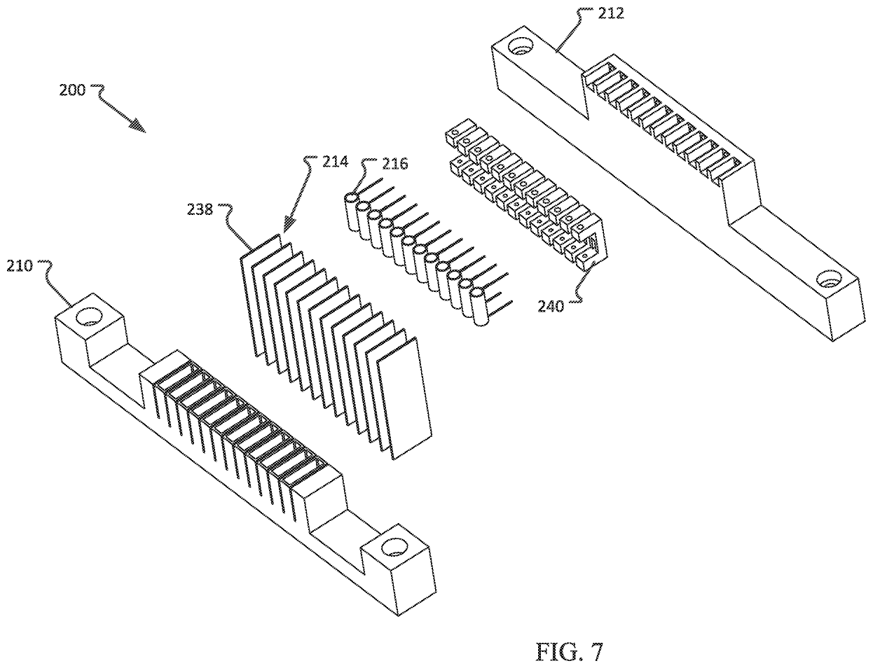

FIG. 7 is another partial perspective exploded view of the device 200. The insulation base 210 supports a plurality of insulation walls 238 that extends outward therefrom and the heating chamber 214 is formed between a pair of insulation walls 238. By at least partially enclosing the heating chamber 214 with insulation walls 238, the temperature within the heating chamber 214 can be more easily controlled for the curing process. In the example, the number of heating chambers 214 corresponds to the number of connectors supportable on the carrier 218 (shown in FIG. 6). The heating element base 212 supports a plurality of heating element mounts 240 that the heating elements 216 couple to. In the example, the heating elements 216 are heating coils that generate heat through a flow of electric current, and a heating coil is disposed within each of the heating chambers 214. The heating chambers 214 are only formed via the insulation base 210 and walls 238, and as such, the chambers 214 are open on all the other sides. These open sides enable the heating element 216 to be positioned within the chamber 214 and so that the optical fiber can easily be positioned within the chamber 214.

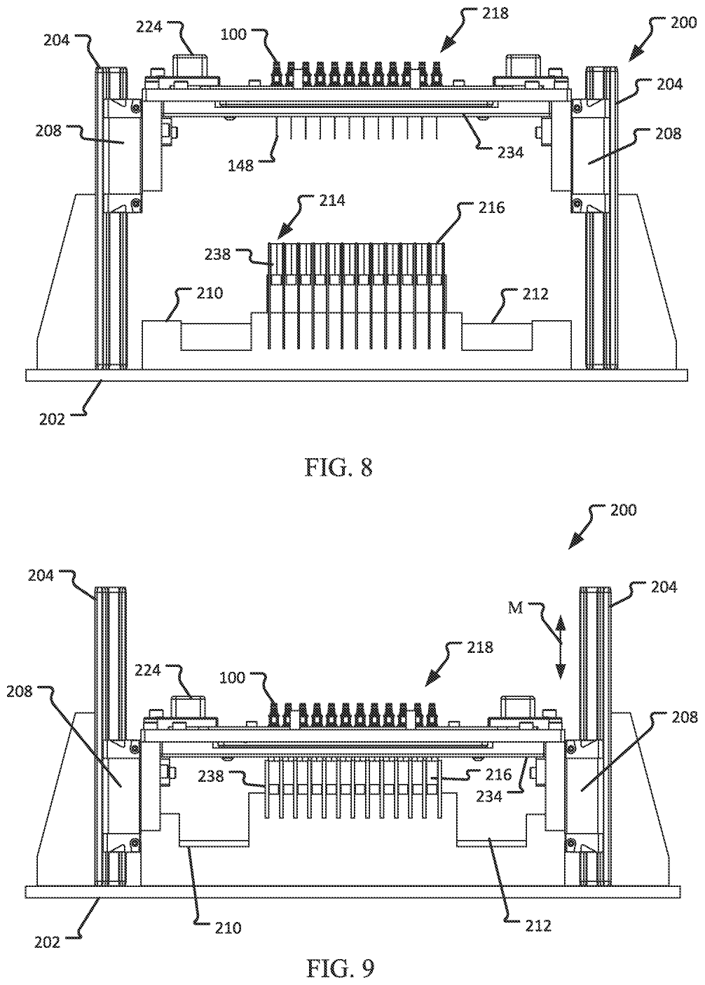

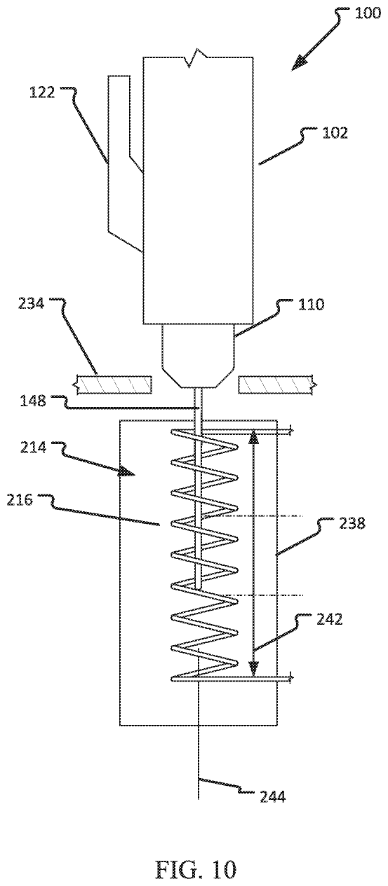

FIG. 8 is a side view of the device 200 in a first position. FIG. 9 is a side view of the device 200 in a second position. FIG. 10 is a schematic view of the second position shown in FIG. 9. Referring concurrently to FIGS. 8-10, certain components are described above, and thus, are not necessarily described further. In operation, the support beam 206 is moved away from the heating chambers 214 and the heating elements 216, and as illustrated in the first position shown in FIG. 8. This position allows for the carrier 218 holding one or more connectors 100 with the exposed portions 148 of the optical fiber extending therefrom to be coupled to the support beam 206 and secured with the latches 224. Additionally, the configuration of the support beam 206 enables for unobstructed access to the exposed portion 148 without needing to contact the optical fibers and the heat shield 234 to be placed around the optical fibers. As described above, the exposed portions 148 have a film of epoxy that is undesirable for the subsequent contacting of the optical fibers within the ferrules. As such, the device 200 enables this film of epoxy to be cured without curing the epoxy within the ferrules.

To cure the film of epoxy on the exposed portion 148, the support beam 206 is moved to the second position as illustrated in FIGS. 9 and 10. In the example, the actuators 208 are configured to travel along the guides 204 so as to linearly move M the support beam 206 and selectively position the connectors 100 relative to the heating chambers 214 and heating elements 216. The movement of the device 200 allows for the exposed portion 148 of the optical fiber to be inserted at least partially within the heating chamber 214 and/or the heating elements 216 without contacting device components and causing uncured epoxy build-up on components. While linear movement M along the guides 204 is illustrated and described, it is appreciated that any other type of movement of the support beam 206 and/or the heating chamber 214 so as insert the exposed portion 148 of the optical fiber into the heating chamber 214 may be used. For example, the support beam 206 may be configured to rotate the connectors 100 into the second position as required or desired. In another example, the base and heating chamber 214 may be configured to move relative to the support beam 206. In still another example, the support beam 206 and the heating chambers 214 may both be configured to move relative to one another.

Once the exposed portion 148 of the optical fiber is within the heating chamber 214, the heating elements 216 are configured to generate heat. The generated heat cures the film of epoxy that is located on the exposed portion 148 so that subsequent physical manipulation of the optical fiber does not result in epoxy built up on assembly device components. In the second position, the ferrule 110 of the connector 100 is not inserted into the heating chamber 214 and is positioned behind the heat shield 234 so that the uncured epoxy within the ferrule is restricted and/or prevented from curing. This epoxy is cured in a later assembly step and after the contacting of the optical fibers. In an aspect, electric current is channeled through the heating coil so as to generate heat, and the current can be used to adjust the amount of heat generated by the heating coil. After the film of epoxy on the exposed portion 148 is cured, the support beam 206 can be moved back to the first position described above.

In the example, the exposed portion 148 is inserted at least partially within an inner diameter of the heating coil for curing the film of epoxy. A length 242 of the heating coil is greater than the length of the exposed portion 148 so that the optical fiber is easily positioned therein. In an aspect, the heating coil is formed from Nichrome. Additionally, the heating temperature for curing the film of epoxy generated by the heating element 216 can be based on one or more control parameters including, DC current, voltage, time period for heating, and/or size of coil (e.g., length, number of turns, diameter, etc.).

As illustrated, each connector 100 has its own heating chamber 214 and heating element 216 within the device 200. As such, the carrier 218 holds twelve connectors 100 and the device 200 has twelve heating chambers 214 and twelve heating elements 216. It is appreciated that curing the film of epoxy on the exposed portion 148 of the optical fiber can be performed by other configurations as well. In one example, a single heating element 216 can be used to cure more than one optical fiber (e.g., a single heating element for 2, 3, 4, 5, etc. number of optical fibers). In another example, a single heating element 216 can be used to cure all of the optical fibers supported on the support beam 206. In other examples, the optical fiber does not need to be inserted into a heating coil and instead can be positioned directed adjacent to the heating coil.

In some examples, a thermocouple 244 can be embedded within the heating chamber 214, or even within the heating coil, that is configured to measure temperature. The thermocouple 244 is utilized to provide a feedback loop for automatic control of the device 200 and the curing process step.

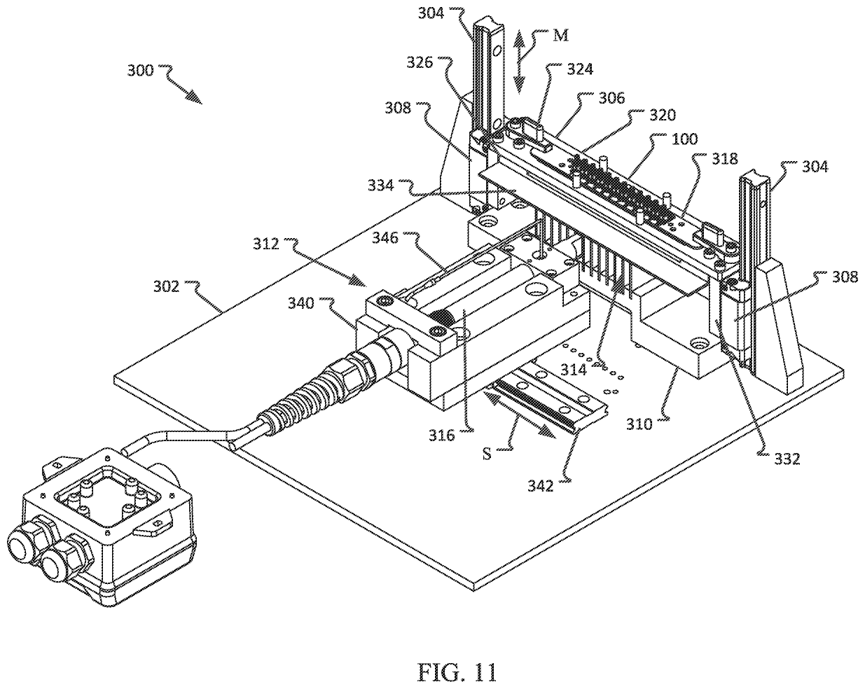

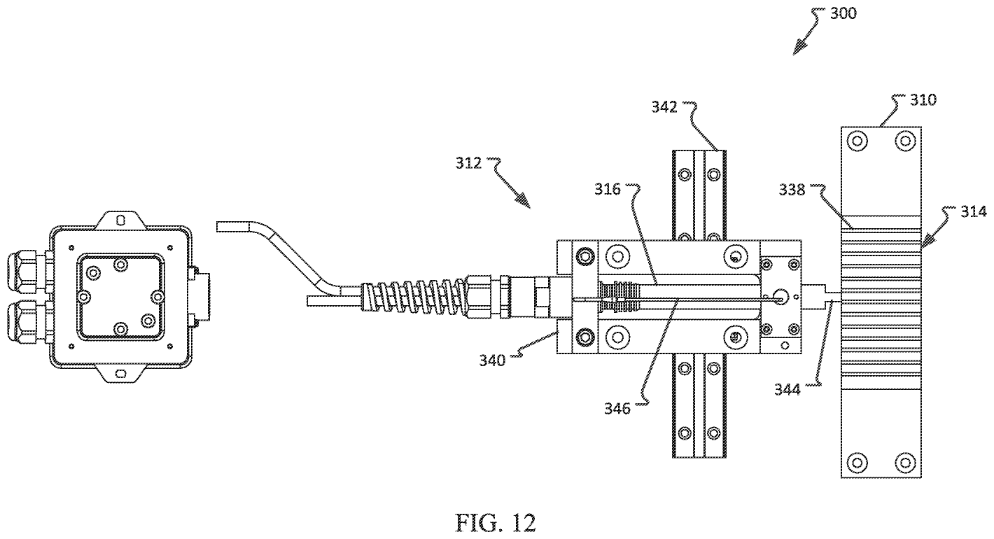

FIG. 11 is a perspective view of another exemplary device 300 for curing a film of epoxy on an optical fiber of a fiber optic connector. FIG. 12 is a partial top view of the device 300. Referring concurrently to FIGS. 11 and 12, the device 300 includes a plate 302 that supports a pair of guides 304. Similar to the example described above, a support beam 306 spans between the guides 304 and is supported at each end by an actuator 308. The actuators 308 are configured to move M the support beam 306 linearly along the guides 304 between two or more positions. An insulation base 310 and a heat assembly 312 are also coupled to the plate 302. The insulation base 310 forms a plurality of heating chambers 314 and the heating assembly supports a movable heating element 316. In operation, the support beam 306 is configured to support one or more fiber optic connectors 100 in a vertical orientation, with respect to the guide 304 direction, such that the exposed portion of the optical fiber can be moved into the heating chamber 314 and the film of epoxy cured.

The support beam 306 is configured to support a carrier 318 such that the carrier 318 can be received and removed as required or desired. The support beam 306 includes the carrier 318, a first member 320, a pair of latches 324, a second member 326, end plates 332, and a heat shield 334 that are similar to those described above in reference to FIG. 6, and thus, are not described further. The insulation base 310 supports a plurality of insulation walls 338, with the heating chamber 314 defined between a pair of insulation walls 338. In the example, the number of heating chambers 314 corresponds to the number of connectors 100 supportable on the carrier 318 (e.g., twelve).

In this example, the heating element 316 is a hot air blower configured to channel a flow of heated air through the heating chamber 314 and so as to cure the film of epoxy on the exposed portion of the optical fiber. The heating element 316 is mounted on a bracket 340 that is configured to slide S along a track 342. The sliding direction of the heating element 316 is substantially orthogonal to the movement direction of the support beam 306 and allows a single heating element 316 to be movably positioned at each heating chamber 314 and provide heat to cure the film of epoxy. The heating element 316 includes a nozzle 344 that is used to index the heating element 316 to each heating chamber 314 and to direct hot air towards the extension portion of the optical fiber. In an aspect, the nozzle 344 is shaped and sized to correspond to the opening size of the heating chamber 314. In some examples, the insulation walls 338 may include one or more baffle elements (not shown) so as to help direct the flow of air within the heating chamber 314 as required or desired.

In operation, the carrier 318 is removably secured to the support beam 306 and the connectors 100 are moved toward the heating chambers 314 so that the exposed portion of the optical fibers are inserted at least partially therein. The heating element 316 then generates a flow of hot air that is selectively channeled through the heating chamber 314 for curing the film of epoxy. The heating temperature for curing the film of epoxy can be based on one or more control parameters including, air temperature, flow rate, and/or time period for heating. In some examples, a thermocouple 346 can be used to measure temperature of the air being expelled from the heating element 316. The thermocouple 346 is utilized to provide a feedback loop for automatic control of the device 300 and the curing process step.

As illustrated, each connector 100 has its own heating chamber 314 and a single heating element 316 moves within the device 300 to each heating chamber 314. As such, the carrier 318 holds twelve connectors 100 and the device has twelve heating chambers 314 and one heating element 316. It is appreciated that curing the film of epoxy on the exposed portion of the optical fiber can be performed by other configurations as well. In one example, a single heating element 316 can be used to cure more than one optical fiber (e.g., a single heating element for 2, 3, 4, 5, etc. number of optical fibers). In an aspect, the nozzle 344 can be configured to reach more than one heating chamber 314, and thus, has more than one nozzle outlets. In another example, multiple heating elements 316 can be used so that each heating chamber 314 has its own heating element 316. In other examples, the heating element 316 may be fixed and the support beam 306 is configured to move relative to the heating element 316.

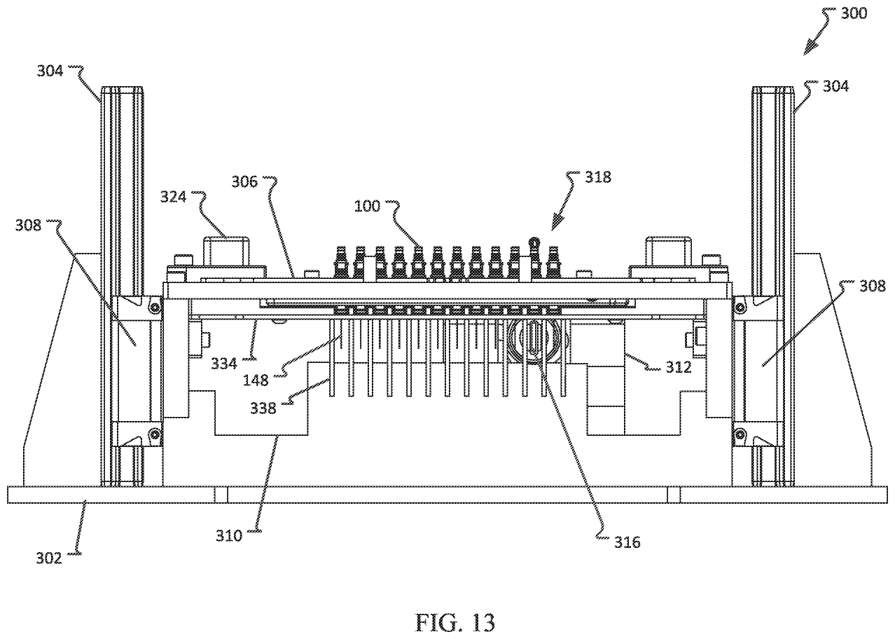

FIG. 13 is a side view of the device 300. Certain components are described above, and thus, are not necessarily described further. In operation, the support beam 306 is moved away from the heating chambers 314. This position allows for the carrier 318 holding one or more connectors 100 with the exposed portions 148 of the optical fiber extending therefrom to be coupled to the support beam 306 and secured with the latches 324. Additionally, the configuration of the support beam 306 enables for unobstructed access to the exposed portion 148 without needing to contact the optical fibers and the heat shield 334 to be placed around the optical fibers. In other examples, the support beam 306 may directly support the connectors 100 as required or desired. As described above, the exposed portions 148 have a film of epoxy that is undesirable for the subsequent contacting of the optical fibers within the ferrules. As such, the device 300 enables this film of epoxy to be cured without curing the epoxy within the ferrules.

To cure the film of epoxy on the exposed portion 148, the support beam 306 is moved to a second position as illustrated in FIG. 13. The movement of the device 300 allows for the exposed portion 148 of the optical fiber to be inserted at least partially within the heating chamber 314 without contacting device components and causing uncured epoxy build-up on components. Once the exposed portion 148 of the optical fiber is within the heating chamber 314, the heating element 316 generates heat and moves between each heating chamber 314. The generated heat cures the film of epoxy that is located on the exposed portion 148 so that subsequent physical manipulation of the optical fiber does not result in epoxy built up on assembly device components. In an aspect, the heating element 316 generates a heated air flow that is channeled through the heating chambers 314. After the film of epoxy on the exposed portion 148 is cured, the support beam 306 can be moved back to and the carrier 318 removed.

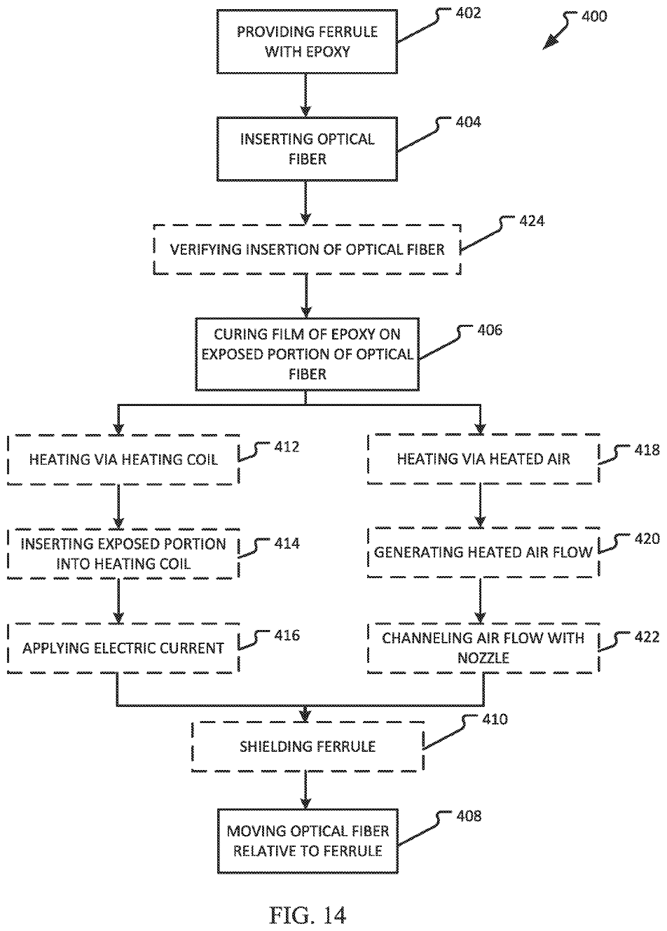

FIG. 14 is a flowchart illustrating an exemplary method 400 of assembling a fiber optic connector such as the fiber optic connector described above in reference to FIGS. 1-3. It is appreciated that the fiber optic connector assembled via the method 400 can be any other type of connector as required or desired.

The method 400 begins with providing a ferrule with epoxy at least partially disposed inside (operation 402) and inserting an optical fiber through the ferrule (operation 404). Operations 402 and 404 result in the optical fiber having an exposed portion disposed outside of the front of the ferrule and an internal portion disposed within the ferrule. Additionally, a film of epoxy is at least partially formed on the exposed portion of the optical fiber. One example of this intermediate connector assembly configuration is illustrated in FIG. 4 and described above.

Because the film of epoxy is formed on the exposed portion of the optical fiber, and the epoxy creates undesirable build-up on assembly device components, the method 400 next includes curing the film of epoxy on the exposed portion of the optical fiber (operation 406). This operation 406 enables downstream assembly processes to be more efficient and the overall assembly process to be improved. Once the film of epoxy is cured, the optical fiber can be moved relative to the ferrule via physical manipulation of the exposed portion (operation 408) and without epoxy build-up on components of the assembly device(s). The physical manipulation may be via direct physical contact or by application of a force such as a flow of air for manipulation of the optical fiber.

In some examples, the method 400 also includes shielding the epoxy inside of the ferrule during the curing of the film of epoxy (operation 410). This shielding step at least partially blocks heat from reaching the epoxy within the ferrule and reduces or completely prevents this epoxy from being cured so that at least a portion of the epoxy inside of the ferrule is left uncured. As such, the optical fiber can be physically manipulated and positioned within the ferrule to increase connector performance during the assembly process of the connector, and this step can occur without epoxy build-up occurring on the contacting device components. This increases connector assembly efficiencies.

Curing the film of epoxy (operation 406) can be performed by many different processes that result in the hardening of the uncured epoxy. In one example, the curing step can include heating the exposed portion of the optical fiber via a heating coil (operation 412). This heating includes inserting the exposed portion of the optical fiber into the heating coil (operation 414), and applying electric current to the heating coil so as to generate a predetermined temperature within the heating coil (operation 416). The amount of heat generated for curing the film of epoxy can be based on one or more adjustable control parameters including, DC current, voltage, time period for heating, and/or size of coil (e.g., length, number of turns, diameter, etc.).

In another example, the curing step can include heating the exposed portion of the optical fiber via heated air (operation 418). This heating includes generating a heated air flow at a predetermined distance from the exposed portion of the optical fiber (operation 420), and channeling the heated air flow via a nozzle to the exposed portion of the optical fiber (operation 422). The amount of heat generated for curing the film of epoxy can be based on one or more adjustable control parameters including, air temperature, flow rate, and/or time period for heat.

The method 400 can also include verifying that the optical fiber is completely inserted into the fiber optic connector (operation 424) prior to curing the film of epoxy (operation 406). This verification step ensures that the subsequent assembly steps can be properly performed as required or desired. Once the optical fiber is properly positioned within the ferrule, the connector assembly process can include curing the epoxy within the ferrule to secure the optical fiber therein. In an aspect, this curing step can also be performed by heat. In other aspects, this curing step may be different than the intermediate curing step described herein. The exposed portion of the optical fiber can then be cleaved off and the front end of the ferrule polished.

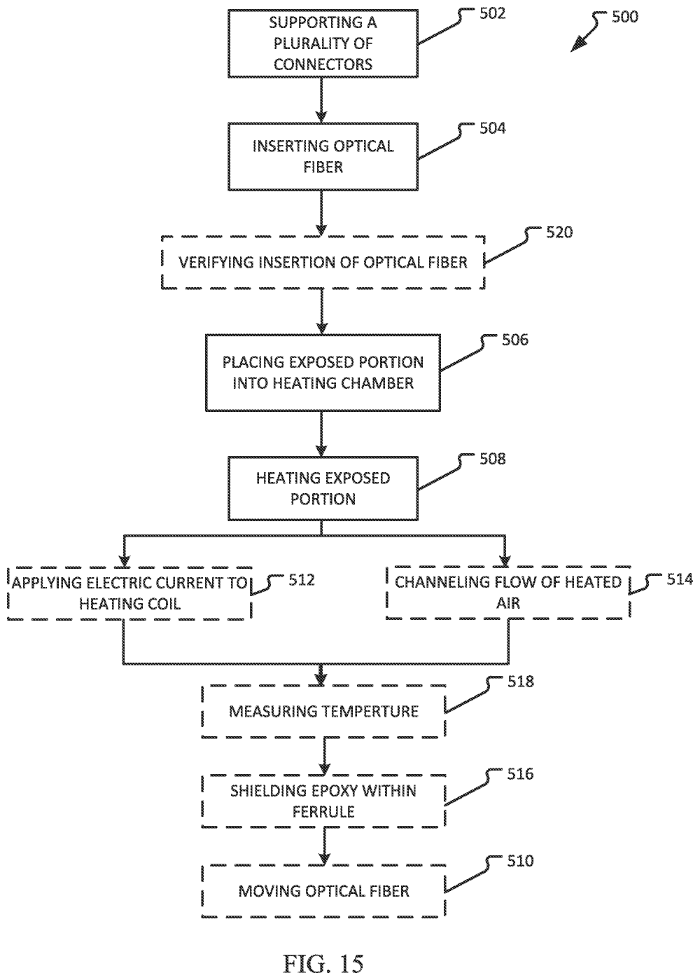

FIG. 15 is a flowchart illustrating another method 500 of assembling a plurality of fiber optic connectors such as the fiber optic connector described above in reference to FIGS. 1-3. It is appreciated that the fiber optic connector assembled via the method 500 can be any other type of connector as required or desired.

The method 500 begins with supporting the plurality of fiber optic connectors in a carrier (operation 502) and each fiber optic connector of the plurality of fiber optic connectors includes a ferrule with epoxy at least partially disposed inside. The method 500 next includes inserting an optical fiber through the ferrule of each of the plurality of fiber optic connectors (operation 504). After insertion, the optical fiber includes an exposed portion disposed outside of the ferrule and an internal portion disposed within the ferrule, and a film of epoxy is at least partially formed on the exposed portion of the optical fiber. In an example, the carrier may be the carrier 218, 318 and shown in FIGS. 6 and 11. The carrier enables the housing of the connectors to be supported while allowing both front end and rear end access to the connectors. Additionally, the carrier can be moved to different assembly devices during the assembly process of the connectors. For example and with respect to the devices described herein, the carrier can be removably received in a support beam while enabling access to the exposed portion of the optical fiber. In other examples, the carrier can be mounted so that the different assembly devices can be selectively moved proximate to the carrier so as to perform the assembly steps as described herein. In still other examples, the support beam may be used to directly support one or more connectors as required or desired.

The exposed portion of each of the optical fibers are then placed into a corresponding heating chamber (operation 506), and the exposed portion is heated within the heating chamber so as to cure the film of epoxy on the exposed portion of the optical fiber (operation 508). With the devices described herein, the carrier is disposed on a support beam that is configured to move relative to the heating chambers. This movement enables the exposed portion to be placed adjacent to the heating elements without the need to physically contact the exposed portion and reduce epoxy build-up on device components. In some examples, after the film of epoxy is cured on the exposed portion, the method 500 can include moving the optical fiber of each of the plurality of fiber optic connectors via physical manipulation of the exposed portion of the optical fiber (operation 510). By curing the film of epoxy prior to moving the fiber, the moving step of the assembly process is more cost effective and efficient because contact with the fiber does not result in epoxy build-up. In some aspects, the moving step can occur while the plurality of fiber optic connectors are still supported in the carrier. After moving the optical fiber, the exposed portion can be cleaved off and the front end of the ferrule polished.

Heating the exposed portion of the optical fiber (operation 508) can be performed by many different processes. In one example, heating the exposed portion includes applying electric current to a heating coil within the heating chamber (operation 512). In another example, heating the exposed portion includes channeling a flow of heated air into the heating chamber (operation 514). It is appreciated that other heating processes are also contemplated herein.

The method 500 can also include shielding the epoxy inside of the ferrule of each of the plurality of fiber optic connectors during the heating (operation 516). This reduces or prevents epoxy located in other areas of the connector from being cured. In an aspect, shielding may include coupling a heat shield to the device that at least partially surrounds the optical fiber. This heat shielding enables for the epoxy inside of the ferrule to remain completely uncured so that subsequent contacting and moving of the optical fiber can be performed. In some examples, the method 500 includes measuring a temperature within the heating chamber so as to provide a feedback loop for heating (operation 518). This temperature measurement can be with a thermocouple as described herein. Additionally or alternatively, the method 500 can also include verifying that each of the optical fibers are completely inserted into the corresponding fiber optic connector of the plurality of fiber optic connectors prior to heating (operation 520).

The various embodiments described above are provided by way of illustration only and should not be construed to limit the claims attached hereto. Those skilled in the art will readily recognize various modifications and changes that may be made without following the example embodiments and application illustrated and described herein, and without departing from the true spirit and scope of the following claims.

1. A method of assembling a fiber optic connector comprising:
providing a ferrule with epoxy at least partially disposed inside;
inserting at least one optical fiber through the ferrule, wherein after insertion, the at least one optical fiber includes an exposed portion disposed outside of the ferrule and an internal portion disposed within the ferrule, and a film of epoxy is at least partially formed on the exposed portion of the at least one optical fiber;
curing the film of epoxy on the exposed portion of the at least one optical fiber; and
moving the at least one optical fiber relative to the ferrule via physical manipulation of the exposed portion of the at least one optical fiber.

2. The method of claim 1, wherein curing the film of epoxy comprises leaving the epoxy inside of the ferrule uncured.

3. The method of claim 1, further comprising shielding the epoxy inside of the ferrule during the curing of the film of epoxy.

4. The method of claim 1, wherein curing the film of epoxy comprises heating the exposed portion of the at least one optical fiber via a heating coil.

5. The method of claim 4, wherein heating the exposed portion comprises:
inserting the exposed portion of the at least one optical fiber into the heating coil; and
applying electric current to the heating coil so as to generate a predetermined temperature within the heating coil.

6. The method of claim 1, wherein curing the film of epoxy comprises heating the exposed portion of the at least one optical fiber via heated air.

7. The method of claim 6, wherein heating the exposed portion comprises:
generating a heated air flow at a predetermined distance from the exposed portion of the at least one optical fiber; and
channeling the heated air flow via a nozzle to the exposed portion of the at least one optical fiber.

8. [Canceled]

9. A method of assembling a plurality of fiber optic connectors comprising:
supporting at least a portion of the plurality of fiber optic connectors in a carrier, wherein each fiber optic connector of the plurality of fiber optic connectors includes a ferrule with epoxy at least partially disposed inside;
inserting at least one optical fiber through the ferrule of each of the plurality of fiber optic connectors, wherein after insertion, the at least one optical fiber includes an exposed portion disposed outside of the ferrule and an internal portion disposed within the ferrule, and a film of epoxy is at least partially formed on the exposed portion of the at least one optical fiber;
placing at least a portion of the exposed portion of the at least one optical fiber of each of the plurality of fiber optic connectors into a corresponding heating chamber; and
heating the exposed portion of the at least one optical fiber within the heating chamber so as to cure the film of epoxy on the exposed portion.

10. The method of claim 9, further comprising moving the at least one optical fiber of each of the plurality of fiber optic connectors via physical manipulation of the exposed portion of the at least one optical fiber.

11. The method of claim 10, wherein the moving step occurs while the plurality of fiber optic connectors are supported in the carrier and after curing the film of epoxy on the exposed portion.

12. The method claim 9, wherein heating the exposed portion includes applying electric current to a heating coil within the heating chamber.

13. The method claim 9, wherein heating the exposed portion includes channeling a flow of heated air into the heating chamber.

14. The method claim 9, further comprising shielding the epoxy inside of the ferrule of each of the plurality of fiber optic connectors during the heating.

15. The method of claim 14, wherein the epoxy inside the ferrule is completely uncured.

16. The method claim 9, further comprising measuring a temperature within the heating chamber so as to provide a feedback loop for heating.

17. [Canceled]

18. A device for curing a film of epoxy on at least one optical fiber of a fiber optic connector, the device comprising:
a carrier configured to support at least one fiber optic connector and allow for at least one optical fiber to be inserted through a ferrule of the at least one fiber optic connector such that an exposed portion is disposed outside of the ferrule and an internal portion is disposed within the ferrule;
a heat shield disposed on one side of the carrier and configured to allow the exposed portion of the at least one optical fiber to extend therethrough; and
an insulation base that defines at least one heating chamber, wherein the at least one heating chamber corresponds to the at least one fiber optic connector, and the at least one heating chamber is configured to at least partially receive the exposed portion of the at least one optical fiber,
wherein the carrier, the insulation base, or the carrier and the insulation base are moveable relative to one another so as to position the exposed portion of the at least one optical fiber at least partially within the at least one heating chamber for heating.

19. The device of claim 18, wherein the at least one heating chamber comprises a heating coil having an inner diameter configured to receive the exposed portion of the at least one optical fiber.

20. The device of claim 18, further comprising a heated air source, wherein the at least one heating chamber is configured to receive a flow of heated air from the heated air source.

21. The device of claim 18, further comprising a thermocouple configured to measure temperature within the at least one heating chamber.

22. A device comprising:
an elongated support beam configured to releasably support at least one fiber optic connector, wherein the fiber optic connector has at least one optical fiber that extends from a front end of the at least one fiber optic connector and is oriented such that the at least one optical fiber is substantially orthogonal to the elongated support beam; and
at least one heating chamber comprising a heating element, wherein the elongated support beam, the at least one heating chamber, or the elongated support beam and the at least one heating chamber are moveable relative to one another so as to position the at least one optical fiber at least partially within the at least one heating chamber for heating.

23. The device of claim 22, wherein the heating element is a heating coil.

24. The device of claim 22, wherein the heating element is a heated air blower.

25. The device of claim 22, further comprising a heat shield disposed between the elongated support beam and the at least one heating chamber.
